(19) United States
(12) Patent Application Publication
(10) Pub. No.: US 2015/0026088 A1
(43) Pub. Date: Jan. 22, 2015

(54) CRIME ASSESSMENT TOOL AND METHOD

(71) Applicant: Walk Score, Inc., Seattle, WA (US)

(72) Inventors: David M. Alber, Seattle, WA (US); Matthew R. Lerner, Seattle, WA (US); Joshua R. Herst, Seattle, WA (US); Mahalie M. Stackpole, Seattle, WA (US)

(21) Appl. No.: 14/331,073

(22) Filed: Jul. 14, 2014

Related U.S. Application Data
(60) Provisional application No. 61/847,848, filed on Jul. 18, 2013.

(51) Int. Cl. G06Q 50/26; G06Q 30/02

(52) U.S. Cl. CPC G06Q 50/265; G06Q 30/0201
USPC 705/325

(57) ABSTRACT

Embodiments of the disclosure are directed towards a crime assessment tool and method for comparing and visualizing crime statistics in a manner such that an accurate assessment of safety in one area may be compared to the safety in another area. The crime statistics may be normalized based on a population basis and/or on crime severity. The areas for comparison may be specified at various levels, such as cities, neighborhoods, specific addresses, or the like. Trending information may be visually provided to aid in assessing the safety of different areas.

### RELATED APPLICATIONS

This application claims priority under 35 U.S.C. Section 119(e) to U.S. Provisional Application Ser. No. 61/847,848 filed Jul. 18, 2013 entitled “System and Method for Comparing and Visualizing Crime Statistics” the disclosure of which is hereby incorporated by reference herein in its entirety.

### BACKGROUND

Crime and safety are top criteria to consider when choosing a place to live or travel. The Federal Bureau of Investigation (FBI) provides Unified Crime Reporting data that identifies crimes and indicates a city or police department where each crime occurred. Crime data may also be obtained from police departments and other agencies. Some of the crime data includes latitude and longitude that specifies a geographic coordinate of a point on the Earth's surface where the crime occurred. The crime data may be displayed on a map that has darker shading in areas having more reported crimes and lighter shading in areas having less reported crime. However, this mapping of crime data may be misleading. In addition, the mapping does not provide the information needed to make an accurate assessment of one's safety in a specific area.

Some organizations have created statistical models to predict crime rates or trends. However, the statistical models are prone to errors, such as statistical errors and incorrect modeling assumptions or techniques. For example, a statistical model may predict more crime in poor neighborhoods, but this prediction may not account for factors that discourage crimes, such as a cohesive community focused on crime prevention, an organized neighborhood watch program, or vigilant enforcement by police in the neighborhood.

### SUMMARY

Embodiments of the disclosure are directed towards a crime assessment tool and method for comparing and visualizing crime statistics in a manner such that an accurate assessment of safety in one area may be compared to the safety in another area. The crime statistics may be normalized based on a population basis and/or on crime severity. The areas for comparison may be specified at various levels, such as cities, neighborhoods, specific addresses, or the like. Trending information may be visually provided to aid in assessing the safety of different areas.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a system view of components for implementing at least one embodiment of the crime assessment tool in accordance with the present disclosure;

FIG. 2 is a flow diagram illustrating an exemplary process for determining the weighted crime rate for an area suitable for use in the components illustrated in FIG. 1;

FIG. 3 is a flow diagram illustrating an exemplary process for determining the weighted per capita crime rate for an area suitable for use in the components illustrated in FIG. 1;

FIG. 4 illustrates a visual representation for a rating indicator suitable for use in the components illustrated in FIG. 1, wherein the rating indicator is based on a letter grading system and the visual representation displays a letter grade for the area;

FIG. 5 illustrates a visual representation for a rating indicator suitable for use in the components illustrated in FIG. 1, wherein the rating indicator is based on a ranking system and the visual representation displays a rank for the area;

FIG. 6 illustrates a visual representation for a rating indicator suitable for use in the components illustrated in FIG. 1, wherein the rating indicator is based on a rating system and the visual representation displays a heatmap having different points within the area having a different shading based on the rating of the associated point;

FIG. 7 illustrates a visual representation for a rating indicator suitable for use in the components illustrated in FIG. 1, wherein the rating indicator is based on a percentile and the visual representation displays a weighted crime rate for an individual address relative to a weighted crime rate for an associated area based on the percentile;

FIG. 8 is a flow diagram illustrating an exemplary process for creating a rating indicator suitable for use in the components illustrated in FIG. 1, wherein the rating indicator includes a crime score being normalized in a manner such that the distribution of the crime score is based on a highest and a lowest crime score in a neighborhood;

FIG. 9 is a flow diagram illustrating an exemplary process for determining trending data suitable for use in the components illustrated in FIG. 1;

FIG. 10 illustrates a display of trending results output from the process illustrated in FIG. 9;

FIG. 11 illustrates an example user interface for obtaining feedback from users regarding their perception of safety in the area suitable for use in the components illustrated in FIG. 1;

FIG. 12 is a functional block diagram representing a computing device for use in certain implementations of the disclosed embodiments or other embodiments of the components, such as illustrated in FIG. 1;

FIG. 13 illustrates two exemplary crime data sources for allowing user-entered crime incidents suitable for use in the components illustrated in FIG. 1; and

FIG. 14 illustrates an exemplary user interface for customizing crime ratings by modifying weights applied to crimes for the system illustrated in FIG. 1.

### DETAILED DESCRIPTION

The following disclosure describes a crime assessment tool and method for comparing and visualizing crime statistics in a manner such that an accurate assessment of safety in one area may be compared to the safety in another area. The crime assessment tool takes into consideration that more crime may occur where there are more people by determining a per capita crime rate. Furthermore, the crime assessment tool considers the severity of the crime by applying different weights to different types of crime to obtain a weighted per capita crime rate for specified areas. The areas for comparison may be specified at various levels, such as cities, neighborhoods, specific addresses, or the like. The crime assessment tool determines a crime indicator, such as a score, a ranking, a letter grade, a percentile, or the like. The crime indicator may be used to compare different areas with each other. The crime assessment tool may use geotagged crime data and thus, provide a more accurate depiction of crime statistics than predictive statistical models. In addition, the crime assessment tool may provide useful trending information to aid in visually assessing the safety of different areas over a period of time.

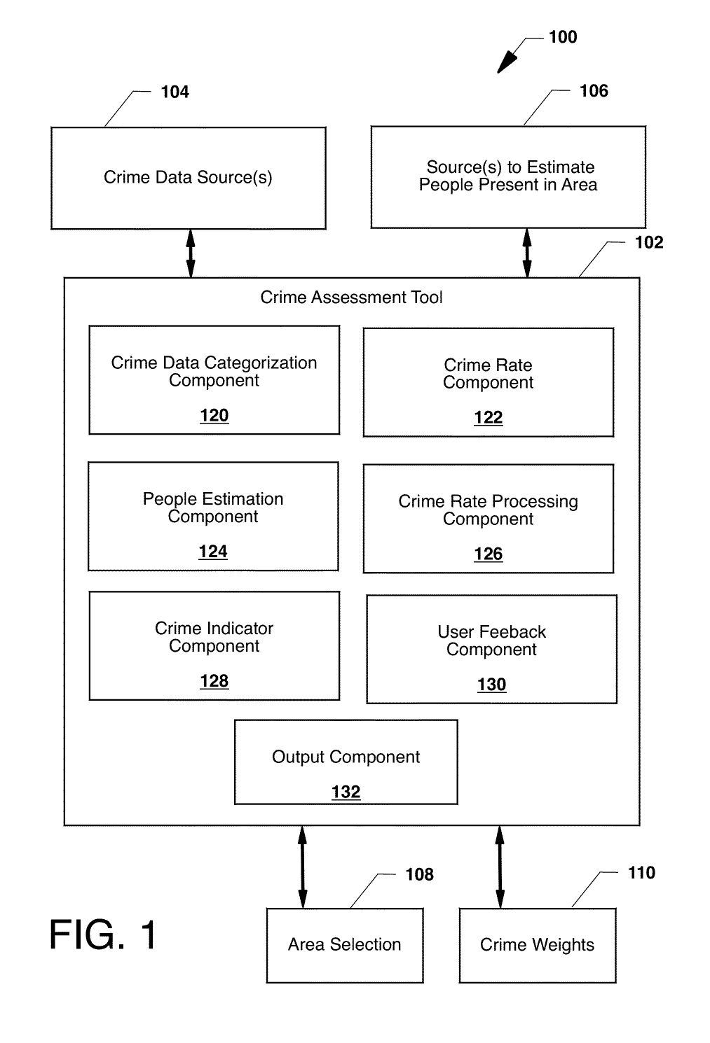

FIG. 1 is a system view of components for implementing at least one embodiment of the crime assessment tool 102 in accordance with the present disclosure. While FIG. 1 and the corresponding description describes several components and interactions between the components, it can be appreciated that the system may include additional or fewer components or the functionality described for one component may be combined with another component without departing from the claimed invention. Thus, the described functionality of the components may be implemented using various permutations and combinations of components. The components may be implemented in software, firmware, and/or hardware, alone or in various combinations.

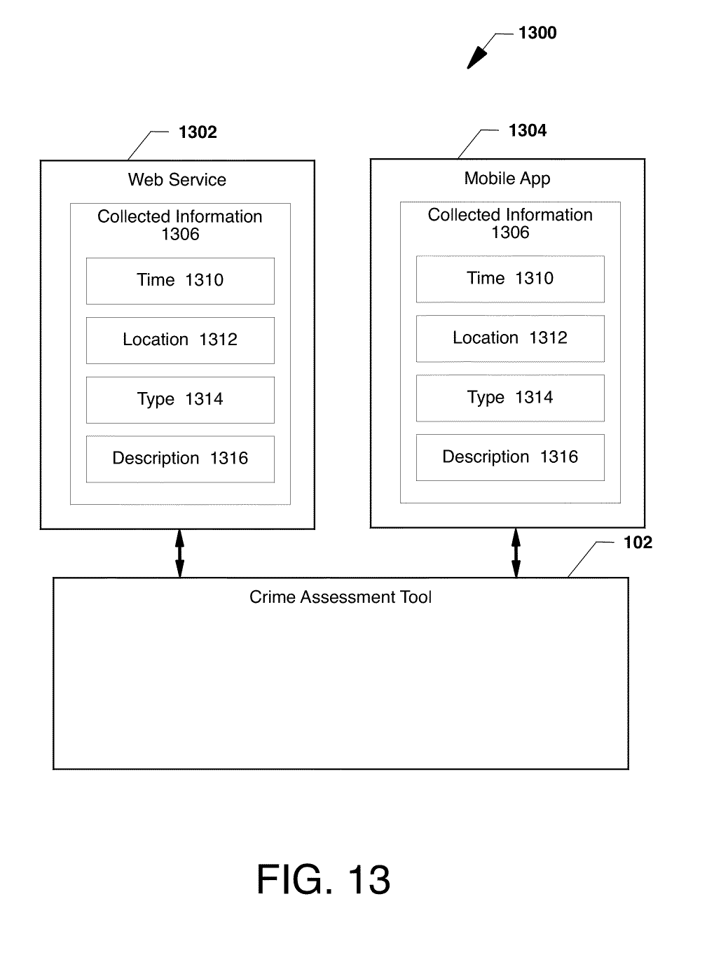

System 100 includes a crime assessment tool 102, one or more crime data sources 104, one or more sources to estimate people present in an area 106, an area selection input 108, and crime weights 110. The crime data sources 104 include crime data from police departments, crime data from third parties via application programming interfaces (APIs) or other web services. Crime data may be imported as various data formats, such as a CSV or JSON file. Some cities provide public access to some or all of their crime report data. While cities may record crime incidents using different fields of data, the crime assessment tool can interpret the different fields to generate useful statistics. In addition to the above mentioned sources, crime data sources 104 may include more timely crime data such as crime data imported by crawling or scraping websites or social media. For example, many cities have crime blotter services—either official, run by news outlets, or private citizens—that report on crimes shortly after incidents occur, or in some instances as the incident is occurring. Some of the crime blotter services may be available as a Really Simple Syndication (RSS) feed that can be easily imported into the crime assessment tool 102. For other crime blotters, the information may be imported using other techniques, such as a commonly known technique of web scraping. Typically, the information obtained from blotters may be more timely than other data sources, but may be less comprehensive than the crime data obtained from other data sources, such as police departments. Crime data sources 104 may also include 911 call data, which can be imported using a process similar to importing crime incident reports from police departments. The system may also allow collection of crime incidents from users. FIG. 13 illustrates two exemplary crime data sources for allowing user-entered crime incidents and will be described in detail later. These and other sources of crime data may be provided as input to the crime assessment tool 102.

The sources to estimate people present in an area 106 may include census data, employment statistics, cell phone usage data, social media data, and the like. One set of census data may provide the number of residents living in an area. However, this set of census data alone may not accurately reflect the people present in the area at different time periods. For example, some downtowns have a small number of residents, but have a large day time population from all the employees who work downtown. Thus, the sources 106 may also include databases of jobs from various sources, such as the Longitudinal Employer-Household Dynamics database from the United States census. Some of the sources 106 may be geocoded so that the data may be analyzed spatially. However, if the sources 106 are not geocoded, the crime assessment tool 102 may be configured to estimate the number of employees and residents in a specified area to obtain the people present in the area for the specified time period. The sources 106 may also include population analytics based on anonymous cell phone data, social signals (e.g., a number of unique tweets occurring in an area), sensors, or the like. For example, a sensor may count pedestrians and this count of pedestrians may be used to further enhance estimates of how many people are actually present in the area. In some embodiments, the information from the sources 106 is input into the crime assessment tool 102 offline, but the information may also be continually updated if so desired.

The area selection 108 provides an area to the crime assessment tool 102 which then may assess the safety of the provided area. The area selection 108 includes techniques for determining a geometry or shape around an address to be analyzed. In some embodiments, the area selection may include commonly available boundary shapefiles, which are datafiles that store information about a geographical or geometrical shape. Shapefiles, for example, are commonly used in the real estate industry and are often made available by city governments. The shapefiles are used to store the boundary shape of neighborhoods. In other embodiments, tthe geometry or shape may be determined using a “walk shed,” which is an area around the address that is walkable in a specified amount of time. The technique described in United States Application No. 2013/0046795 may be used to determine the “walk shed” and is hereby incorporated by reference in its entirety. Using a “walk shed” to analyze nearby crimes provides an accurate way to determine which crimes are likely to affect an address (e.g., a home). For example, crimes on one side of a busy freeway are less likely to affect the quality of life of residents living on the other side of the freeway. The walk shed may be based on any interval of time and the area determined by the walk shed is determined to be the area from which a person can walk from a specified address in any direction for the specified interval of time (e.g., 15 minutes). The end points in each direction define an outer boundary for the walk shed.

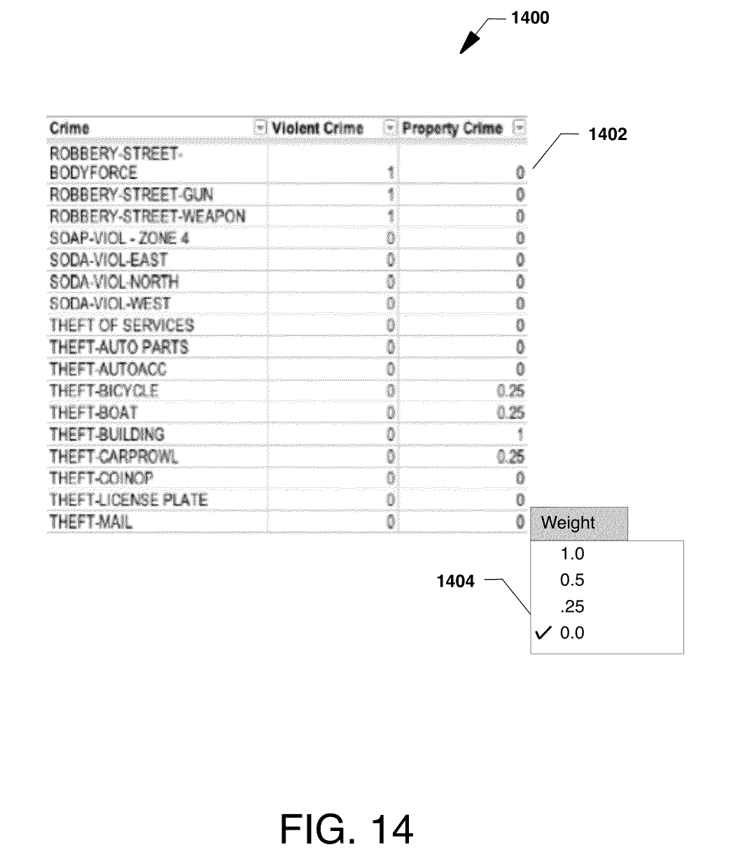

Crime weights 110 may be supplied. In some embodiments, the weight of a crime may depend on the severity of the crime. For example, a minor property crime such as a broken car window may have a lower weight than an armed robbery of a home. Weights based on the severity of violent crimes may be applied correspondingly. For example, a murder may have a higher weight than an assault. Crimes that are not location based (e.g., fraud) may be given a weight of zero, thereby excluding the crime in the assessment for the area. In addition, some crimes may have a different weight in each of the categories of crimes in which the crime is categorized. For example, an armed robbery of a house may have the same or different weight for both a violent crime and a property crime category. FIG. 14, described later in more detail, illustrates an example of a set of customizable weights that may be applied to various crimes in various categories.

The crime assessment tool 102 may include a crime data categorization component 120, a crime rate component 122, a people estimation component 124, a crime rate processing component 126, a crime indicator component 128, a user feedback component 130, and an output component 132. The crime data categorization component 120 receives the crime data from the crime data sources 104. The fields of interest in the crime data include time, location, and category of the incident. The crime data sources 104 may report the crime data using different fields and in addition, different cities may categorize crimes differently. For example, the city of Seattle currently has 190 unique categories of crime, while the city of Houston currently has eight unique categories. The crime data categorization component 120 may translate these different classification schemes into a single categorization system. In addition, the crime data categorization component 120 may translate location information into a consistent format for use by the crime assessment tool 102. In some embodiments, different representations may be translated into latitude and longitude coordinates. If block-level addresses are provided, the crime assessment tool 102 may employ a third party service to translate the block-level addresses to obtain latitude and longitude coordinates using a process called geocoding. If x,y coordinates are used to specify the crime location, the crime data categorization component 120 may translate the x,y coordinates using details about the projection used in determining the x,y coordinates.

The crime data categorization component 120 may categorize crimes in various ways. In some embodiments, crime may be categorized as a property crime or a violent crime. In other embodiments, crime may be categorized by a level of severity. In other embodiments, crime may be categorized as a personal crime or a property crime. It will be appreciated that in addition to the above-mentioned schemes, combinations of the above schemes and other categorization schemes may be used by the crime assessment tool 102. The inventors of the present crime assessment tool 102 have discovered that by weighting crimes by severity, the crime assessment tool 102 can more accurately assess crime statistics and decrease noise. For example, while property crimes occur everywhere, applying the same weight to graffiti as to a home burglary results in a less accurate assessment of the risk to personal property. In addition, by weighting crimes by severity, the crime assessment tool can achieve more accurate comparisons between neighborhoods. In one embodiment, severe crimes may be weighted with a value of 1, less severe crimes may be weighted with a value of 0.25, and crimes that are not location specific or crimes that do not result in any impact to the quality life may be given a value of 0. As briefly discussed above and discussed further in conjunction with FIG. 14, the weights may be user defined in a manner so that the user may influence the safety assessment to more closely match the user's perceptions of safety.

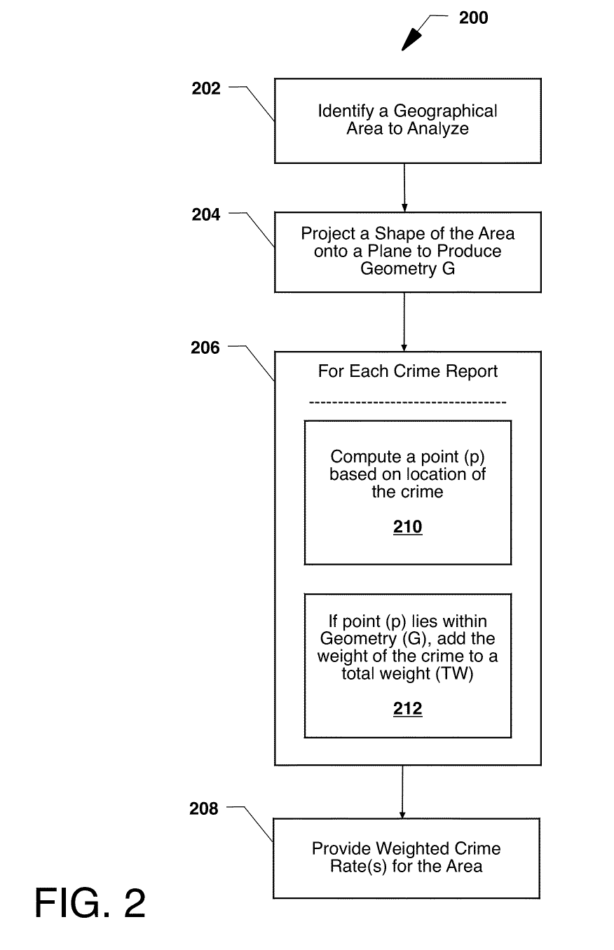

Crime rate component 122 determines a weighted crime rate for an area in question. The area being considered may be input from the area selection 108, such as a shapefile or walk shed. The process for determining the weighted crime rate is illustrated in FIG. 2 and described in detail later in conjunction therewith. However, as discussed above, crime rates alone are not particularly useful because the crime rates do not reveal the likelihood that an individual will be a victim of a crime in a specific area. Therefore, the crime assessment tool normalizes the crime rate by a number of people that are in an area at a given time as will be described below.

People estimation component 124 estimates the number of people that are present in the area at a specified time. Estimates of the people present may be created at various times of the day. For example, a daytime estimate may include the working population during working hours and subtract out the number of residents who commute away from the area. The people estimation component may estimate the people present by using anonymous cell phone location data to predict or analyze the estimate on an hourly basis. For example, available services may be used to estimate the people present in an area at a specified time using anonymous cell phone data.

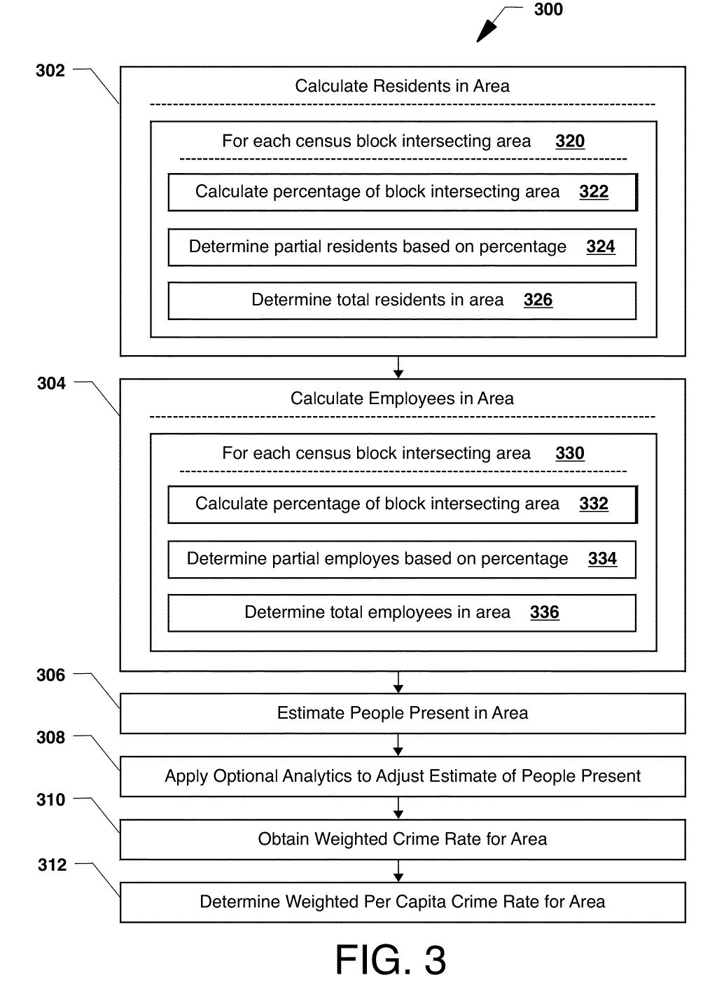

Crime rate processing component 126 determines a weighted per capita crime rate in an area. The weighted per capita crime rate is determined by dividing the total weighted crime rate in an area by the estimate of people present in the area for a specified time period. The weighted per capita crime rate may be determined for different crime categories, such as determining the weighted per capita crime rate for violent crimes and property crimes, separately. In addition, the weighted per capita crime rate may be determined for different periods of time, such as daytime hours versus nighttime hours. Determining weighted per capita crime rate using different time periods may be useful in indicating differences in crime rates that are dependent on different types of crimes. For example, having daytime and nighttime periods may help indicate whether a neighborhood is unsafe during the day, during night, or both. By assigning a value to each time period, crime statistics may be used to compare daytime and nighttime safety between neighborhoods or cities. Using time periods aids in comparisons since some crowded area (e.g., a downtown tourist attraction) may be safe during the day when there are more people, but may be unsafe at night when there are fewer people. It can be appreciated that any number of additional time periods may be used in determining crime statistics per capita. For example, time periods may be computed on a monthly or seasonal basis to identify particular times of the year that are safer or less safe than other times of the year in a given neighborhood, city, or geographic area, thereby providing trending information. FIG. 3 is a flow diagram illustrating an exemplary process for determining a weighted per capita crime rate for an area and will be described in detail later in conjunction therewith. Table 1 illustrates a table with weighted per capita crime rates for an area. As illustrated in Table 1, the crime assessment tool 102 may provide a total count of crimes (column 1), a daytime count of crimes (column 3), and/or a nighttime count of crimes (column 5) for different addresses or neighborhoods. Each row in Table 1 represents a different area (e.g., neighborhood). Columns 2, 4, and 6 in Table 1 illustrate a corresponding weighted per capita crime rate for an entire day, a daytime period, and nighttime period, respectively. One will appreciate that while Table 1 illustrates the weighted per capita crime rates for crimes classified as violent, the crime assessment tool may also output information on the weighted per capita crime rates for other crime classifications, such as property crimes and the like.

TABLE 1
Weighted Per Capita Crime Rates

| | | | Violent | | Violent |
|---|---|---|---|---|---|
| | Violent | Violent | Daytime | Violent | Nightime |
| Violent | Rate | Daytime | Rate | Nightime | Rate |
| 3566 | 0.0032236 | 1941 | 0.0017546 | 1625 | 0.0014689 |
| 40 | 0.0158188 | 25 | 0.0098867 | 15 | 0.0059320 |
| 33 | 0.0148332 | 10 | 0.0044949 | 23 | 0.0103383 |
| 78 | 0.0118434 | 48 | 0.0072882 | 30 | 0.0045551 |
| 137 | 0.0117405 | 76 | 0.0065130 | 61 | 0.0052275 |
| 28 | 0.0098782 | 14 | 0.0049391 | 14 | 0.0049391 |
| 68 | 0.0078963 | 34 | 0.0039481 | 34 | 0.0039481 |
| 63 | 0.0078482 | 40 | 0.0049830 | 23 | 0.0028652 |
| 28 | 0.0072733 | 17 | 0.0644159 | 11 | 0.0028573 |
| 73 | 0.0071138 | 36 | 0.0035082 | 37 | 0.0036056 |
| 34 | 0.0067221 | 28 | 0.0055359 | 6 | 0.0011862 |
| 30 | 0.0065338 | 12 | 0.0026135 | 18 | 0.0039202 |
| 197 | 0.0063532 | 70 | 0.0022574 | 127 | 0.0040957 |
| 34 | 0.0061769 | 23 | 0.0041785 | 11 | 0.0019984 |
| 231 | 0.0057166 | 66 | 0.0016333 | 165 | 0.0040833 |
| 38 | 0.0050355 | 24 | 0.0031803 | 14 | 0.0018552 |
| 33 | 0.0049906 | 13 | 0.0019659 | 20 | 0.0030246 |
| 62 | 0.0047913 | 40 | 0.0030912 | 22 | 0.0017001 |

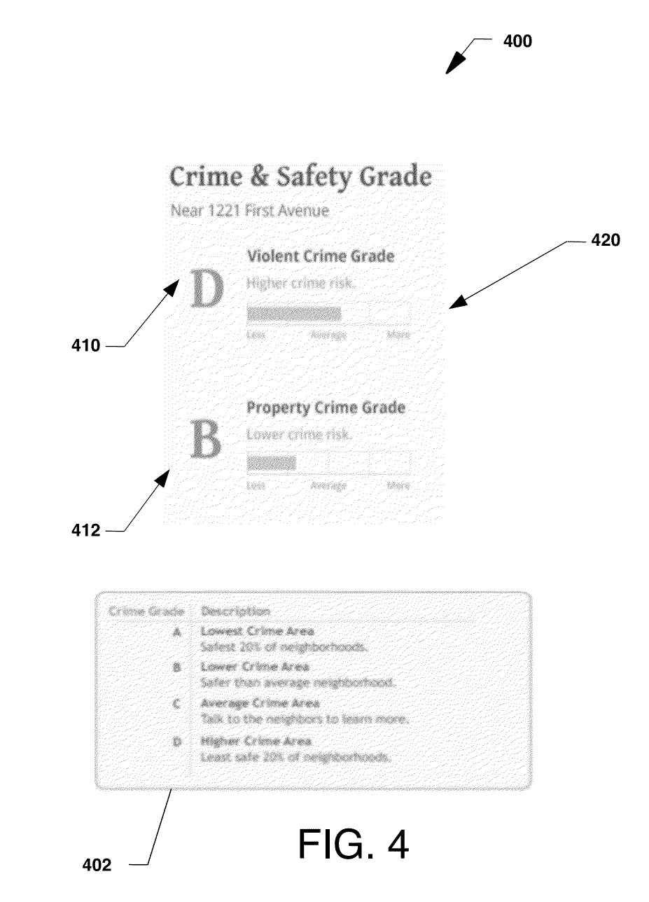

Crime indicator component 128 is configured to create a rating indicator for specified areas. Because it is often difficult for individuals to compare crime rates since crime rates are typically reported in incidents per thousand people, crime indicator component 128 may normalize the crime rates into a rating indicator. The crime indicator component 128 may base the rating indicator on individual addresses, neighborhoods, cities, national statistics, or the like depending on a desired comparison. In addition, the crime indicator component 128 may normalize the rating indicator to further refine the safety assessment calculated for specified areas and aid in presenting helpful visual representations of the safety assessment. FIGS. 4-7 illustrate exemplary visual representations for various rating indicators and each will be described later in conjunction therewith.

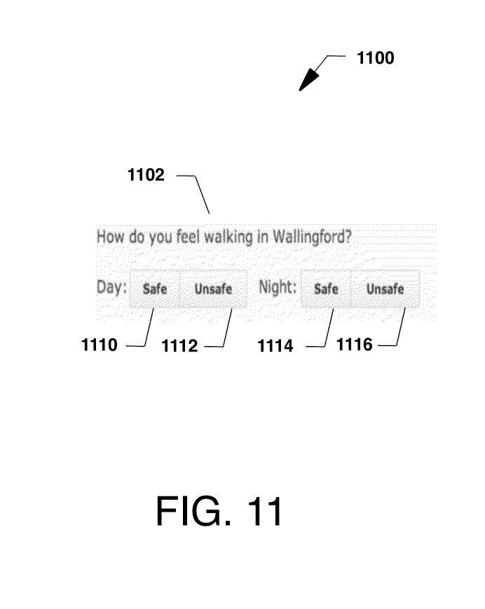

User feedback component 130 accepts input from a user of the crime assessment tool and incorporates the feedback into the crime assessment. Oftentimes, the perception of whether an area is safe is a meaningful factor on whether people actually feel safe in an area. The user feedback component 130 collects feedback from users. The crime assessment tool 102 may be provided as a network accessible application, such as a web page specified by a Uniform Resource Identifier (“URI”) and displayable via a web browser, or, may be provided via a server or as a web service and integrated into another, perhaps third party, application. The user feedback component 130 may use any conventional method for inputting data. FIG. 11 illustrates an example user interface for obtaining feedback from users regarding their perception of safety in the area and will be discussed later in more detail.

Output component 132 provides visual displays for easily assessing the safety of specified area. It will be appreciated that various visual representations, such as a ranking, a letter grade, a percentage, a numerical representation (e.g., a score), symbolic representations (e.g., a star rating system), a graphic/iconic/symbolic representation (e.g., a map with icons), or the like may be output. Several of these various visual representations are illustrated in FIGS. 4-7 and described below in conjunction with the respective FIGURE. Output component 132 may provide a visual display of crime rates in relation to city-wide averages. This visual display helps in determining how one neighborhood compares to the city overall. Current crime maps simply show how many crimes are reported, but do not give any sense of a per capita odds of being affected by a crime in any area. In other embodiments of the present crime assessment tool 102, output component 132 may display only areas with a particular high per capita crime rate, thereby allowing a quick assessment of unsafe areas.

Output component 132 may also provide a display in which crime trends are illustrated over time for a specified area (e.g., city, neighborhood, address). The display of the crime trends may, for example, provide insight into questions regarding safety during the summer when students are not at school, safety in correlation with weather, safety in correlation with the economy in an area, and the like.

FIG. 2 is a flow diagram illustrating an exemplary process for determining a weighted crime rate for an area that is suitable for use in the components illustrated in FIG. 1. As mentioned above, because merely mapping crime locations on a map does not accurately reflect the safety of one area in comparison with another area, the crime assessment tool 102 may determine a weighted crime rate for a desired area. The area may be a specific address, a neighborhood, a city, a county, or any other area of interest. At block 202, a geographical area is identified for analysis. As described above, the area has a geometry that may be defined using a shapefile, a walk shed, or other boundary defining technique. The area may be specified by a user by entering a name of a city, a name of neighborhood, or a specific address into a user interface of the crime assessment tool. The geographical area that is identified may be based upon the manner in which the area is specified. For example, if a specific address is entered, the geographical area may be identified using a walk shed, a circle with a set radius from the specific address, or the like. In other embodiments, if the area is specified as a neighborhood or city, the geographical area may be identified using a corresponding shapefile. However, one will appreciate that any method of identifying the geographic area may be used by the crime assessment tool without departing from the scope of the claimed invention.

At block 204, the crime assessment tool projects a shape of the area onto a plane to produce a geometry G. At block 206, the crime assessment tool analyzes the crime reports in the database to determine a location associated with the crime report. At block 210, a point p is computed by projecting latitude and longitudinal coordinates of the crime. In some embodiments, the location may be specified using latitude and longitudinal coordinates in a manner that the location identifies point p. In other embodiments, once an area is determined for analyzing crime statistics, standard geospatial techniques may be implemented to determine which crimes occurred within the boundary of the area. At block 212, if a point p lies within geometry G, the weight of the associated crime is added to a total weight (TW) that represents the weighted crime rate for an area. One will appreciate that multiple weighted crime rates may be calculated using process 200 separately or concurrently. One exemplary illustration of a weighting scheme is illustrated in FIG. 13 where crimes have different weights based on the categorization of the crime and the severity. For some embodiments, a weighted crime rate may be calculated for different categories of crime (e.g., a weighted property crime rate, a weighted violent crime rate, and the like). The crime assessment tool may be configured to determine which weighted crime rates to calculate based on input from a user, based on default settings, or the like. At block 208, the one or more weighted crime rates are made available so that the crime assessment tool may use the weighted crime rates in further processing.

FIG. 3 is a flow diagram illustrating an exemplary process for determining the weighted per capita crime rate for an area, which is suitable for use in the components illustrated in FIG. 1. As mentioned above, during conception of the crime assessment tool, the inventors realized that merely mapping crime locations on a map did not accurately reflect the safety of one area in comparison with other areas. Therefore, the present crime assessment tool may be configured to determine a weighted per capita crime rate that factors in the number of people present in an area with regards to the crime reported. In overview, the weighted per capita process 300 estimates the number of people present in an area and divides the weighted crime rate for the area determined in FIG. 2 by the number of people present to obtain the weighted per capita crime rate for the area. Process 300 is now described in detail in which the crime assessment tool uses census data to determine the people present in the area.

At block 302, the crime assessment tool calculates the residents in the area based on census blocks. At block 320, for each census block intersecting the area, the crime assessment tool performs blocks 322, 324, and 326. If the census block does not intersect the area, the census block may be ignored. At block 322, the crime assessment tool calculates a percentage of the census block that intersects the area. At block 324, the calculated percentage is multiplied by the total residents identified for that census block to obtain a partial resident count associated with the census block. At block 326, the partial resident count for the census block is added to a running total of partial resident counts from each of the intersecting census blocks. After all of the census blocks that intersect with the area have been processed, the sum of all the partial resident counts yields the estimated total number of residents in the area. In some embodiments, as a further refinement, a number of residents that commute out of the area for the specified time period may be determined and subtracted from the estimated total number of residents to yield a new estimated total of residents in the area.

At block 304, the crime assessment tool calculates the employees in the area. At block 330, for each census block intersecting the area, the crime assessment tool performs blocks 332, 334, and 336. If the census block does not intersect the area, the census block may be ignored. At block 332, the crime assessment tool calculates a percentage of the census block that intersects the area. One will appreciate that this percentage may yield the same percentage as block 332 if the same census block provides both resident information and employee information. For this embodiment, the percentage calculated for block 322 may used without re-calculating the percentage in block 332, if so desired. At block 334, the calculated percentage is multiplied by the total number of employees identified for that census block to obtain a partial employee count for the census block. One will appreciate that the number of employees may be based on the number of jobs identified for the census block. At block 336, the partial employee count for the census block is added to a running total of partial employee counts from each of the intersecting census blocks. After all of the census blocks that intersect with the area have been processed, the sum of all the partial employee counts yields the estimated total number of employees in the area. In a further refinement, unemployment data, job openings, or other job related data may be reflected in the total number of employees in the area by adjusting the partial employee count for each block, adjusting the total number of employees, or the like.

At block 306, the total number of residents from block 302 is summed with the total employees from block 304 to yield an estimate for the number of people present in the area for a specified time period.

At block 308, additional analytics may be applied to adjust the estimated number of people present. The crime assessment tool may optionally employ population analytics based on anonymous cell phone data, social signals (e.g., a number of unique tweets occurring in an area), sensors, or the like. For example, a sensor may count pedestrians and this count of pedestrians may be used to further enhance estimates of how many people are actually present in the area at a specified time period.

At block 310, the weighted crime rate for the area is obtained as determined during processing in FIG. 2. As mentioned above, one or more weighted crime rates for the area may be obtained, such as a weighted property crime rate and/or weighted violent crime rate.

At block 312, the weighted crime rate is divided by the estimated number of people present in the area to yield the weighted per capita crime rate for the area. The weighted per capita crime rate for different area calculations may then be used to visually represent a safety assessment for areas of interest. FIGS. 4-7 illustrate exemplary visual representations for various rating indicators and will now each be described.

FIG. 4 illustrates a visual representation 400 for a rating indicator 402 suitable for use in the components illustrated in FIG. 1, wherein the rating indicator 402 is based on a letter grading system (e.g., Grades A-D) and the visual representation displays a letter grade 410 and 412 for weighted per capital crime rate for different categories of crimes in the area. In addition, visual representation 400 may include a bar chart 420 rating indicator reflective of the assigned letter grade. In some embodiments, the letter grading system may include a letter grade A representing the lowest crime area corresponding to the safest 20% of neighborhoods, a letter grade B representing a lower crime area corresponding to a safer than average neighborhood, a letter grade C representing an average crime area, and a letter grade D representing a higher crime area corresponding to a least safe 20% of neighborhoods. The letter grades may be used to rate an address, a neighborhood, a city, or other area with respect to crime safety. The letter grading system may be based on the weighted per capita crime rate determined during process 300 for various addresses in a neighborhood which are then graded per the rating indicator 402. In other embodiments, the letter grading system may be based on the weighted per capita crime rate determined during process 300 for various neighborhoods which are then graded per the rating indicator 402. In other embodiments, other areas (e.g., cities) may be similarly graded per the rating indicator 402 after determining the weighted per capital crime rate via process 300.

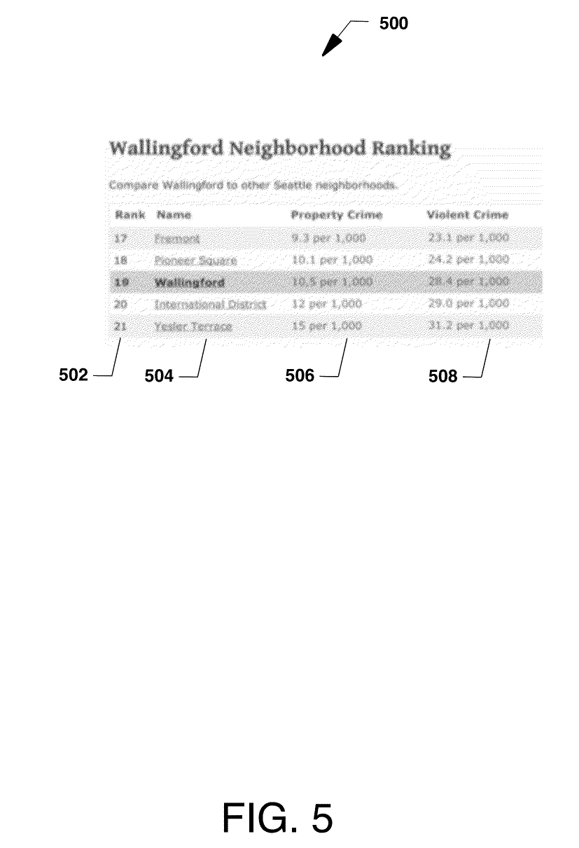

FIG. 5 illustrates a visual representation for a rating indicator suitable for use in the components illustrated in FIG. 1, wherein the rating indicator is based on a ranking system and the visual representation displays a rank for the area. In the visual representation 500, the area(s) of ranking are neighborhoods. The visual representation 500 ranks similar neighborhoods in a manner to allow end-users to quickly get a sense whether a neighborhood is safe relative to its peers. Visual representation 500 may be a table that may be easily sorted by the end-user on any of the available fields. In some embodiments, the fields may include a rank field 502, a name of the area field 504, a property crime field 506, and/or a violent crime field 508. The property crime field 506 and the violent crime field may use weighted crime rates and/or weighted per capita crime rates as discussed above. It will be appreciated that additional fields may be added without departing from the claimed invention and one or more of the fields 502-508 may be omitted without departing from the claimed invention. While FIG. 5 illustrates rankings for similar neighborhoods, visual representation 500 may also rank specific addresses in a neighborhood, city, or the like.

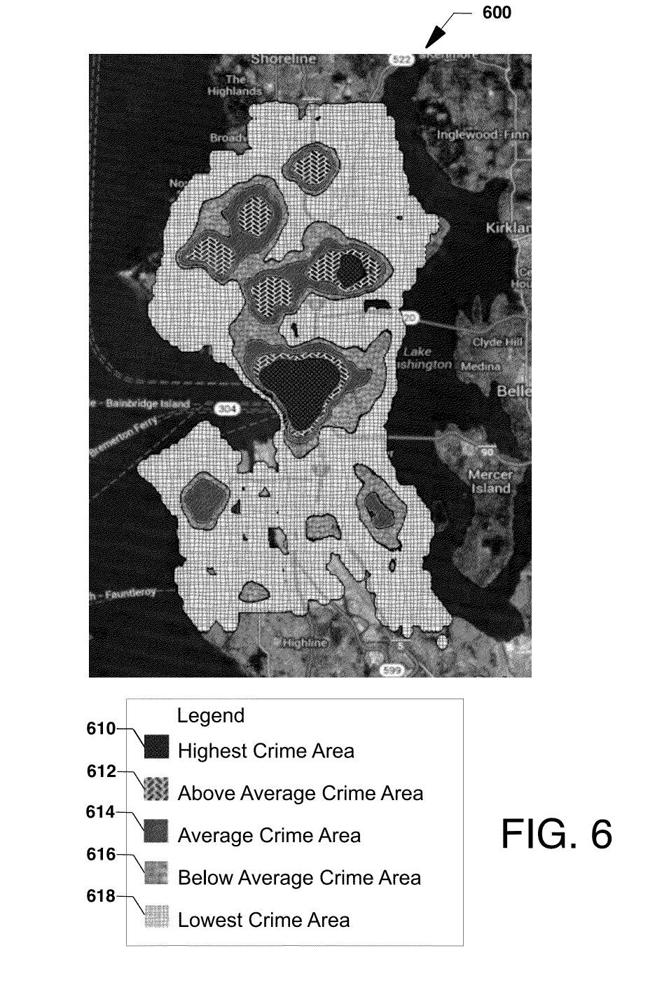

FIG. 6 illustrates a visual representation 600 for a rating indicator suitable for use in the components illustrated in FIG. 1, wherein the rating indicator is based on a grey-scale and/or color coding rating system and the visual representation displays a heatmap having different points within the area having a different shading based on the rating of the associated point. Visual representation 600 illustrates a five grey scale coding rating system. Grey scale 610 represents the highest crime area, grey scale 612 represents an above average crime area, grey scale 614 represents an average crime area, grey scale 616 represents a below average crime area, and grey scale 618 represents a lowest crime area. It will be appreciated that more than five grey scales or less than five grey scales may be used for the rating system without departing from the claimed invention. In addition, the grey scale may be a color coded system. The heatmap may be generated after processing several specific addresses to obtain the weighted per capita crime rate as illustrated in FIG. 3 and then selectively associating the specific address to one of the grey scales based on the associated weighted per capita crime rate in comparison with the weighted per capita crime rate for other specific addresses. In the visual representation 600, for each grid point in the heatmap, a per capita crime rate may be calculated at the grid cell using process 300 as described above. The per capita crime rate may then be mapped onto the heatmap based on the rating system of the heatmap. In some embodiments, low per capita crime rate grid cells may be transparent so that the user's attention can be better focused on the grid points corresponding to medium and/or high per capita crime rates.

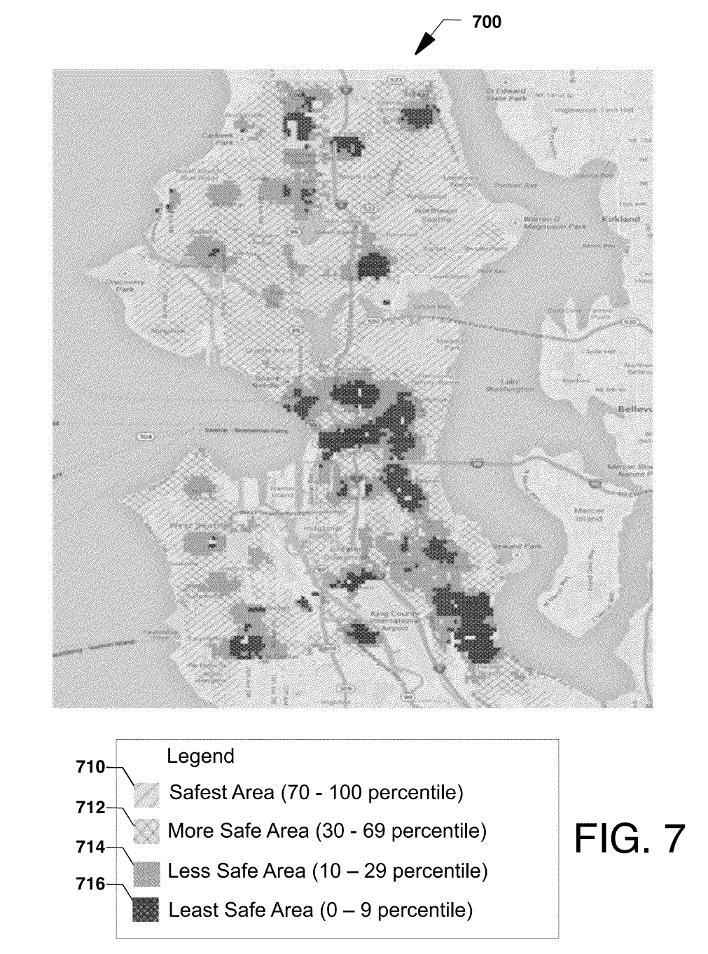

FIG. 7 illustrates a visual representation for a rating indicator suitable for use in the components illustrated in FIG. 1, wherein the rating indicator is based on a percentile and the visual representation displays a weighted crime rate for an individual address relative to a weighted crime rate for an associated area based on the percentile. In the percentile ranking, the percentile ranking may be determined after calculating neighborhood weighted crime rates and the specified address weighted crime rate. The percentile ranking may be determined by comparing the specified address weighted crime rate to neighborhood weighted crime rates. As discussed above, the weighted crime rates may be further optimized based on the classification scheme of crimes (e.g, violent, property). In other embodiments, the percentile ranking may be based on a national percentile. In other embodiments, percentiles may be computed by comparing a specified address weighted crime rate against other selected address weighted crime rates. Visual representation 700 illustrates four percentiles 710, 712, 714, and 716. Percentile 710, displayed using diagonal lines, represents the safest area and includes 30% of the area of interest. Percentile 712, displayed using crosshatching, represents the next safest area and includes 40% of the area of interest. Percentile 714, displayed using gray shading, represents a less safe area and includes 20% of the area of interest. Percentile 716, displayed using white points on black, represents the least safe area and includes 10% of the area of interest. Those skilled in the art will appreciate that additional percentile groups and percentages may be used without departing from the scope of the claimed invention. In addition, the percentiles may be represented using a rating system such as a letter grading system (e.g., A, B, C, D). Table 2 illustrates exemplary pseudocode for determining a percentile ranking of an address against other addresses.

TABLE 2
Pseudocode for Determining Percentile Ranking

```
function compute_point_scores(point)
      property_weight = violent_weight = 0
      distance = ⅓
      for incident in crime_incidents_within_distance(point, distance):
            property_weight += incident.property_weight
            violent_weight += incident.violent_weight
      population = population_within_distance(point, distance)
      num_jobs = jobs_within_distance(point, distance)
      num_people = population+num_jobs
      property_weight_rate = property_weight/(num_people)
      violent_weight_rate = violent_weight/(num_people)
      neighborhood_property_weight_rates =
      all_neighborhood_property_weight_rates( )
      neighborhood_violent_weight_rates =
      all_neighborhood_violent_weight_rates( )
return percentile(neighborhood_property_weight_rates,
property_weight_rate),
      percentile(neighborhood_violent_weight_rates,
      violent_weight_rate)
```

While the above visual representations for displaying various rating indicators are helpful in comparing safety between different addresses, neighborhoods, cities, and the like, the rating indicators do not provide information for users to understand the safety of each area based on the actual crime rates, but rather comparisons with other areas. For example, in FIG. 5, a user may be able to easily compare different neighborhoods based on their rankings, but the user may not fully understand how safe each of the neighborhoods are because the weighted per capita crime rate is reported in incidents per thousand people. Therefore, in some embodiments, the crime assessment tool may be further configured to normalize the weighted per capita crime rates to yield a crime score that may be distributed based on a highest crime rate and a lowest crime rate. The crime score may be normalized on a city level, a multi-city level, or the like. If the crime rates are normalized on a city level, the calculated crime scores may be compared with other crime scores calculated in the same city. By normalizing the crime rates at a city level, a greater resolution of the crime scores may be achieved between the neighborhood crime scores. In some embodiments in which the weighted per capita crime rates are normalized at a multi-city level, the crime assessment tool may allow neighborhoods from different cities to be compared using the normalized crime scores. However, because not all cities have high crime neighborhoods, the crime assessment tool may be further configured to handle these situations.

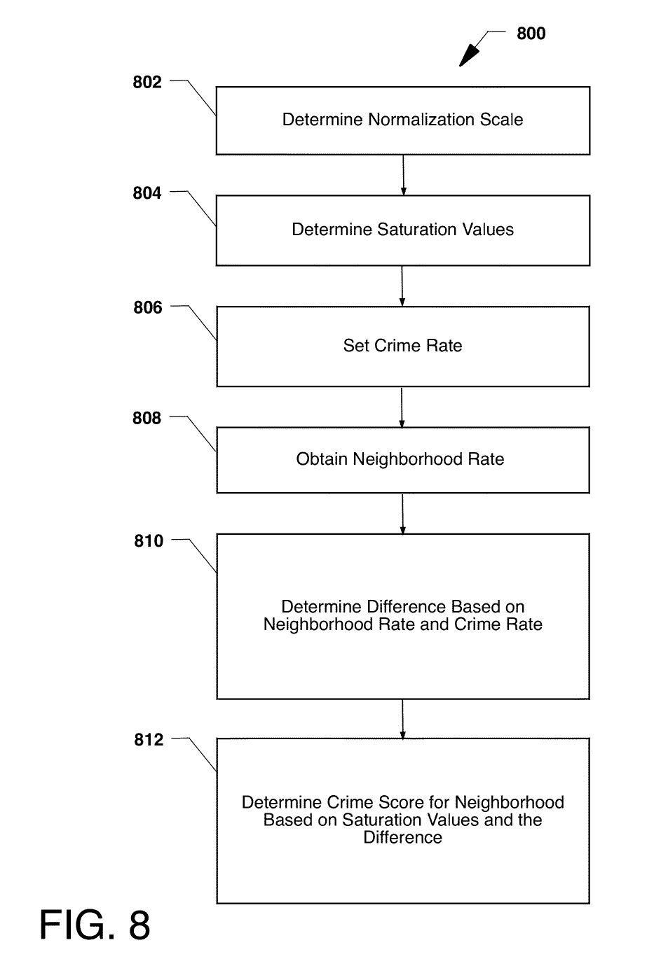

FIG. 8 is a flow diagram illustrating an exemplary process for creating a rating indicator suitable for use in the components illustrated in FIG. 1 wherein the rating indicator includes a crime score calculated by normalizing the weighted per capita crime rate in a manner such that the distribution of the crime score is based on a highest and a lowest weighted per capita crime rate in a neighborhood. At block 802, a normalization scale is determined. A logarithmic scale or other distribution may be used to ensure an even distribution of scores across neighborhoods. In one exemplary embodiment, the normalization scale may be based on normalizing crime rates between a highest crime rate and a lowest crime rate using a score between 0 to 100. In other embodiments, the normalization scale may be a 10 point scale, a symbolic representation (e.g., a star rating system), a graphic/iconic/symbolic representation or the like.

At block 804, the crime assessment tool determines saturation values. The saturation values include a minimum saturation value and a maximum saturation value. The minimum saturation value and the maximum saturation value are constants that define values, relative to an average crime rate, that are used to obtain a score of 0 or 100, respectively. By implementing saturation values, the crime assessment tool handles situations where a city may not have a high crime neighborhood.

At block 806, the crime assessment tool sets a crime rate. When the normalization is based on a city level, the crime rate is set to reflect a city rate. In some embodiments, the crime rate is set to 50 when the normalization is based on a city level. The crime rate provides a metric for comparing neighborhoods in a city to one another. Because some neighborhoods are less safe than the city's general safety and some neighborhoods are more safe than the city's general safety, the crime rate is set as a pivot point to divide the two classes of neighborhoods. The crime rate may be set an any arbitrary value. In some embodiments, the crime rate is set at or near the middle, such as 50 for a range between 0 to 100.

At block 808, the crime assessment tool obtains a neighborhood rate for evaluation. The neighborhood rate may be obtained using process 300 illustrated in FIG. 3 and described above.

The neighborhood rate corresponds to the weighted per capita rate calculated for the specified area (i.e., neighborhood).

At block 810, the crime assessment tool determines a difference based on the neighborhood rate and the crime rate. In some embodiments, the difference may be determined by dividing the neighborhood rate by the crime rate and subtracting a value, such as 1, thereby grouping the neighborhood being evaluated into one of the two general classes: the more safe neighborhood class or the less safe neighborhood class.

At block 812, the crime assessment tool determines a crime score for the neighborhood based on the saturation values and on the difference. In overview, the crime score provides a rating indicator that normalizes crime rates in a manner that allows different neighborhoods in the same city or different cities to be compared with one another. The crime score takes into account that some cities may not have high crime neighborhoods. Table 4 illustrates exemplary pseudocode determining a crime score for neighborhoods in a city.

TABLE 3
Pseudocode for Determining a Crime Score

```
function getCrimeScore(city, neighborhood):
      city_rate = city.get_crime_rate( )
      neighborhood_rate = neighborhood.get_crime_rate( )
      neighborhood_diff = neighborhood_rate/city_rate − 1
      if diff <= 0:
            diff = max (diff, min_saturation)
            return 50*(diff − min_saturation)/|min_saturation|
      else:
            diff = min(diff, max_saturation)
            return 50*diff/max_saturation
```

In some embodiments, the min saturation is set to −1 and the max saturation is set to 1. With these settings, a neighborhood with a crime rate of at most 100% less than the city rate (i.e., no crime) is assigned a crime score of 0 and a neighborhood with at least 100% higher crime rate than the city rate is assigned a score of 100.

The process 800 illustrated in FIG. 8 may be used to normalize crime rates at an address level, a city level, a multi-city level, a national level, and/or international level. The crime rate is set according to the level being normalized and obtaining the neighborhood rate is determined according to the level being normalized. For example, for normalizing crime rates at an address level, the neighborhood rate may correspond to an individual address where the weighted per capita crime rate is based on an area surrounding the individual address as described above in conjunction with FIG. 3.

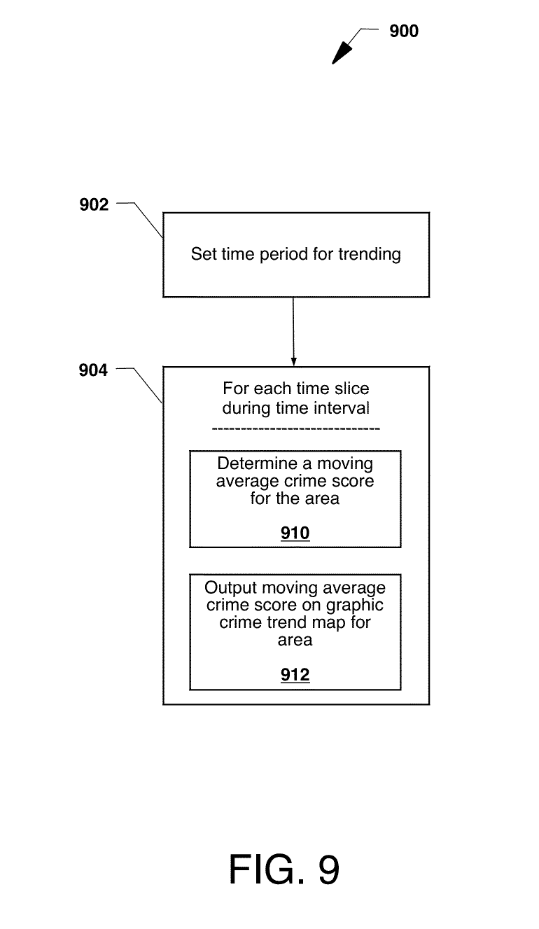

FIG. 9 is a flow diagram illustrating an exemplary process 900 for determining trending data suitable for use in the components illustrated in FIG. 1. At block 902, a time period is set for trending, such as a year, multiple years, or the like. At block 904, for each time slice during the time interval a moving average crime score is determined for the area at block 910 and the moving average crime score is output graphically on a trend map associated with the area at block 912. The time slice may be any interval within the time period. Typically, the crime score for each time slice has been previously stored. While the interval may be set to any amount, because of fluctuations between different intervals, the crime assessment tool may employ a moving average crime score in order provide a more smooth graph. In addition, having too small of time slices introduces unnecessary noise into the visualization. In one embodiment, a three-month moving average is employed to illustrate trending over a calendar year. By tracking crime over time at both the address and neighborhood level, the present crime assessment tool provides insight into questions such as whether the safety of an area changes when students are in school versus out of school, whether safety is impacted by hot weather, the economy, or the like.

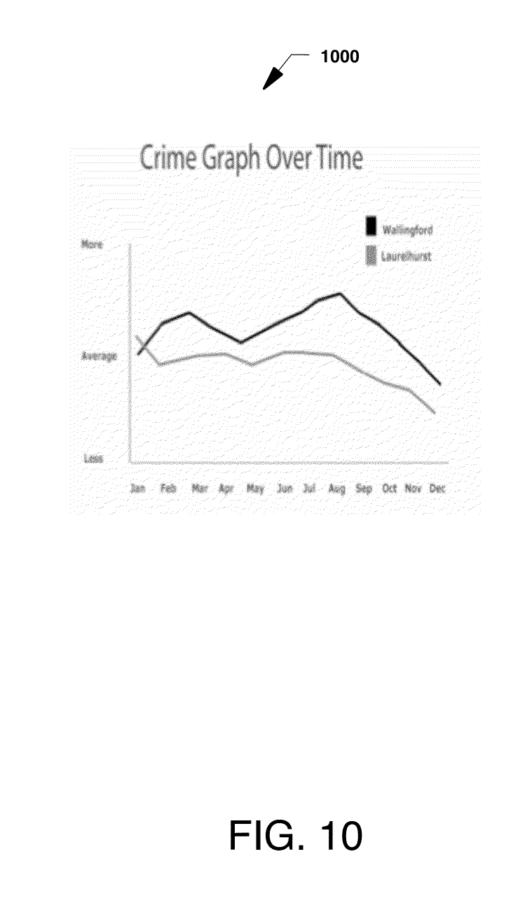

FIG. 10 illustrates a display of trending results output from the components illustrated in FIG. 1. Graph 1002 represents a three-month moving average of crime scores for a neighborhood named Wallingford over a one year calendar year and graph 1004 represents a three-month moving average of crime scores for a neighborhood named Laurelhurst. Both graph 1002 and 1004 show a decrease in per capita crime in September.

FIG. 11 illustrates an example user interface 1100 for obtaining feedback from users regarding their perception of safety in the area. User interface 1100 may include a question 1102 regarding safety and buttons (e.g., buttons 1110-1116) to indicate a user's response, such as “safe” or “unsafe”. User interface 1100 may include multiple sets of buttons where each set is for a specific time period, such as Day or Night. After the user feedback component 130 obtains a sufficient number of user generated feedback, the user generated feedback may be incorporated into one or more of the various rating indicators. Various techniques may be used to incorporate user generated feedback into the crime rate processing. For example, a bonus or a penalty may be added to a crime score based on whether a statistically significant number of votes indicated the neighborhood was safe or unsafe.

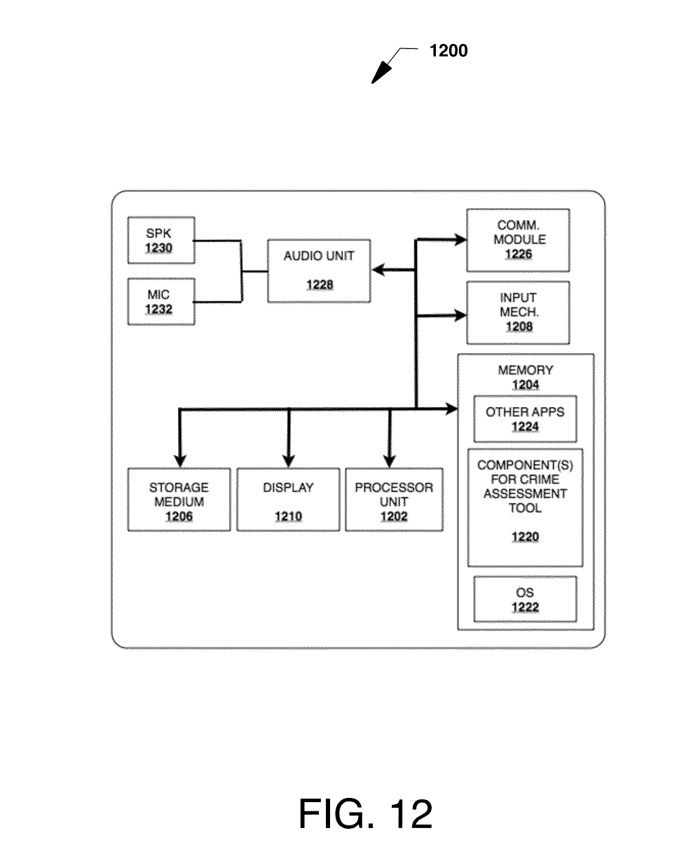

FIG. 12 is a functional block diagram representing a computing device suitable for use for the crime assessment tool. The computing device 1200 may include various types of computing systems. For example, in some embodiments, the computing device may be a desktop computing system executing a Web browser that may be used by a user to interactively obtain information from the crime assessment tool. In some other embodiments, the computing device may be a mobile computing device (e.g., a mobile phone, tablet, phablet) having location aware functionality (e.g., a GPS system). The GPS-capable mobile computing device may provide an indication of the current location of the mobile phone to the crime assessment tool which may be used to report a crime incident and/or show a current safety indicator for the location. The computing device 1200 includes a processor unit 1202, a memory 1204, a storage medium 1206, an input mechanism 1208, and a display 1210. The processor unit 1202 advantageously includes a microprocessor or a special purpose processor such as a digital signal processor (DSP), but may in the alternative be any conventional form of processor, controller, microcontroller, state machine, or the like.

The processor unit 1202 is coupled to the memory 1204, which is advantageously implemented as RAM memory holding software instructions that are executed by the processor unit 1202. These software instructions represent computer-readable instructions and computer executable instructions. In this embodiment, the software instructions stored in the memory 1204 include components (i.e., computer-readable components) for a crime assessment tool 1220, a runtime environment or operating system 1222, and one or more other applications 1224. The memory 1204 may be on-board RAM, or the processor unit 1202 and the memory 1204 could collectively reside in an ASIC. In an alternate embodiment, the memory 1204 could be composed of firmware or flash memory.

The storage medium 1206 may be implemented as any nonvolatile memory, such as ROM memory, flash memory, or a magnetic disk drive, just to name a few. The storage medium 1206 could also be implemented as a combination of those or other technologies, such as a magnetic disk drive with cache (RAM) memory, or the like. In this particular embodiment, the storage medium 1206 is used to store data during periods when the computing device 1200 is powered off or without power. The storage medium 1206 could be used to store crime rates, crime scores, weights, trend data, and the like. It will be appreciated that the functional components may reside on a computer-readable medium and have computer-executable instructions for performing the acts and/or events of the various method of the claimed subject matter. The storage medium being on example of computer-readable medium.

The computing device 1200 also includes a communications module 1226 that enables bi-directional communication between the computing device 1200 and one or more other computing devices. The communications module 1226 may include components to enable RF or other wireless communications, such as a cellular telephone network, Bluetooth connection, wireless local area network, or perhaps a wireless wide area network. Alternatively, the communications module 1226 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 1228 may be a component of the computing device 1200 that is configured to convert signals between analog and digital format. The audio unit 1228 is used by the computing device 1200 to output sound using a speaker 1230 and to receive input signals from a microphone 1232. The speaker 1232 could also be used to announce incoming calls.

A display 1210 is used to output data or information in a graphical form. The display could be any form of display technology, such as LCD, LED, OLED, or the like. The input mechanism 1208 includes keypad-style input mechanism and other commonly known input mechanisms. Alternatively, the input mechanism 1208 could be incorporated with the display 1210, such as the case with a touch-sensitive display device. Other alternatives too numerous to mention are also possible.

FIG. 13 illustrates two exemplary crime data sources for allowing user-entered crime incidents suitable for use in the components illustrated in FIG. 1. In one embodiment, a web service 1302 may be provided. The data collected by the web service 1302 may overlap with other crime data sources or may augment the other crime data sources. For example, the web service 1302 may collect information that does not get reported to police. The additional information may be data relevant to users of the crime assessment tool, but not necessarily a reportable crime. In some other embodiments, a mobile application 1304 may be provided. The mobile application 1304 may allow users to report crime incidents as the incident is occurring. The location of the crime incident may be obtained directly from the device executing the mobile application 1304 without requiring the user to enter a location for the incident. For both embodiments, the collected information 1306 may include a time of incident 1310, a location 1312 for the incident, a type 1314 of incident, and/or a description 1316. The time of incident 1310 may be automatically entered based on when the user enters the information or the user may enter a specific time. The location 1312 may be entered by the user, by clicking on a map, verbally stating an address, or the like. The type 1314 of incident may be selectable from a predefined set of categories. The description 1316 may be entered by the user using voice input, keyboard input, or other input techniques.

FIG. 14 illustrates an exemplary user interface 1400 for customizing crime ratings by modifying weights applied to crimes for the system illustrated in FIG. 1. User interface 1400 allows users to alter or influence the weights which impacts the generation of crime scores. By adjusting the weights, users may generate crime scores that more closely match their own perception of safety. In some embodiments, user interface 1400 may be a table which the user may enter a value for the weight in a field 1402 for each type of crime. In other embodiments, each field may have a drop down menu 1404 listing the available weights which the user may select. A combination of these and other techniques are envisioned to allow user modification of the weights.

While the foregoing written description of the invention enables one of ordinary skill to make and use a crime assessment tool as described above, those of ordinary skill will understand and appreciate the existence of variations, combinations, and equivalents of the described embodiments, methods, and examples herein. In addition, those skilled in the art will appreciate that the crime assessment tool may be used for providing safety assessments for real estate services, travel and vacation services, urban planning, and others. Thus, the invention as claimed should therefore not be limited by the above described embodiments, methods, and examples, but by all embodiments and methods within the scope and spirit of the claimed invention.

The claimed invention is:

1. A system for assessing crime statistics, the system comprising:
a memory for storing computer-readable instructions associated with a crime assessment tool; and
a processor programmed to execute the computer-readable instructions to enable the crime assessment tool, wherein when the computer-readable instructions are executed, the system is programmed to:
compute a crime assessment for a first area based on a plurality of crimes occurring within the first area, where each of the plurality of crimes is weighted to reflect a severity level, the crime assessment being further based on an estimate of people in the first area; and
output the crime assessment.

2. The system of claim 1, further comprising determining the first area by selecting a geometry associated with the first area.

3. The system of claim 2, further comprising determining the geometry by determining a walk shed associated with a specified address.

4. The system of claim 1, wherein the estimate of people comprises a resident population and an employment population for the first area.

5. The system of claim 1, wherein the estimate of people is based upon cellular phone usage within the first area.

6. The system of claim 1, further comprising computing another crime assessment for the first area, wherein the crime assessment for the first area is based on the estimate of people in the first area during a first time frame and the other crime assessment is based on the estimate of people in the first area during a second time frame.

7. The system of claim 1, further comprising obtaining user feedback regarding a perceived safety for the first area and incorporating the user feedback into the crime assessment.

8. The system of claim 1, further comprising displaying the crime assessment as a ranking of the first area with additional areas.

9. The system of claim 1, further comprising storing the crime assessment at pre-determined intervals and displaying stored crime assessments to show trending information regarding the first area.

10. The system of claim 1, wherein the crime assessment comprises a weighted per capita crime rate for the first area and the weighted per capita crime rate is normalized for comparison with other areas.

11. The system of claim 1, further comprising applying user-customized weights for each of the plurality of crimes to reflect the severity level.

12. The system of claim 1, further comprising obtaining user-generated incident reports and incorporating the user-generated incident reports into the crime assessment.

13. A computer-implemented method for assessing crime statistics, the computer-implemented method comprising:
computing a crime assessment for a first area based on a plurality of crimes occurring within the first area, where each of the plurality of crimes is weighted to reflect a severity level, the crime assessment being further based on an estimate of people in the first area; and
outputting the crime assessment.

14. The computer-implemented method of claim 13, further comprising determining the first area by selecting a geometry associated with the first area.

15. The computer-implemented method of claim 14, further comprising determining the geometry by determining a walk shed associated with a specified address.

16. The computer-implemented method of claim 13, wherein the estimate of people in the first area is based a resident population and an employment population for the first area.

17. The computer-implemented method of claim 13, wherein the estimate of people in the first area is based upon cellular phone usage within the first area.

18. The computer-implemented method of claim 13, further comprising computing another crime assessment for the first area, wherein the crime assessment for the first area is based on the estimate of people in the first area during a first time frame and the other crime assessment is based on the estimate of people in the first area during a second time frame.

19. The computer-implemented method of claim 13, further comprising obtaining user feedback regarding a perceived safety for the first area and incorporating the user feedback into the crime assessment.

20. The computer-implemented method of claim 13, further comprising obtaining user feedback regarding a perceived safety for the first area and incorporating the user feedback into another crime assessment for the first area.

21. The computer-implemented method of claim 13, further comprising storing the crime assessment at pre-determined intervals and displaying stored crime assessment to show trending information regarding the first area.

22. A computer-readable media storing computer-readable components executable by a computing device, the computer-readable components comprising:
a crime assessment component configured to compute a crime assessment for a first area based on a plurality of crimes occurring within the first area, where each of the plurality of crimes is weighted to reflect a severity level, the crime assessment being further based on an estimate of people in the first area, and p1 an output component to output the crime assessment for comparison with another crime assessment computed for a second area.
